(19) United States
(12) Patent Application Publication
(10) Pub. No.: US 2026/0017093 A1
(43) Pub. Date: Jan. 15, 2026

(54) TIME SIMULATION FOR A COMPUTING SYSTEM

(71) Applicant: Apple, Inc., Cupertino, CA (US)

(72) Inventors: Nicholas J. LOUKAS, Brooklyn, NY (US); Jorge L. Perea Ramos, Scarsdale, NY (US); Jian LV, Oakland Gardens, NY (US); Seth L. Charlip-Blumlein, Brooklyn, NY (US); Jonathan L. Cutler, Brooklyn, NY (US); Oleksandr Prushynskyy, Los Gatos, CA (US); Derek Bacon, San Jose, CA (US)

(73) Assignee: Apple, Inc., Cupertino, CA (US)

(21) Appl. No.: 18/769,042

(22) Filed: Jul. 10, 2024

(51) Int. Cl. G06F 9/48; G06F 9/54

(52) U.S. Cl. CPC G06F 9/4881; G06F 9/547; G06F 2209/486; G06F 2209/543

(57) ABSTRACT

A computing device can include a system clock and a processor coupled to the system clock. The system clock can be configured to indicate a current time of the computing device that is approximately equal to a real physical time. A time adaption layer can be operated by the processor and include a time simulator to provide a simulated current time that is substantially different from the real physical time. A first program can be operated by the processor based on the current time provided by the system clock at the real physical time. In addition, a second program can be operated based on the simulated current time provided by the time simulator at the same real physical time.

### BACKGROUND

### Field

This disclosure is generally directed to time simulation for a computing system.

### Background

A computing device can use a system clock within the computing device to synchronize the operations performed by hardware components of the computing device. When software performs operations related to a current time of the computing device, the software can read the current time from the system clock of the computing device. However, there can be a small difference between the system clock and the real physical time. The real physical time can be measured by a time standard such as the atomic time standard or the ephemeris time standard based on the earth's orbital period or the motion of the moon. Even when initially set accurately, the system clock of a computing device can differ from the real physical time after some amount of time due to clock drift or other physical causes.

A computing system can include one or more computing devices including hardware or software components that facilitates computing. A computing system can be a centralized computing system that has a global clock to which computing devices of the centralized computing system can be synchronized. In addition, a distributed computing system can include a collection of computer programs that utilize computational resources across multiple and separated computing devices. A distributed system does not share a global clock among its computing devices. Accordingly, time synchronization can be an important service in the distributed system that enables event ordering and coordinated communication. A clock synchronization solution can include the network time protocol (NTP), or using global positioning system (GPS) for clock synchronization.

How to effectively control the time provided to a software of a computing system, either a centralized computing system or a distributed computing system, can have many challenges.

### SUMMARY

Provided herein are system, apparatus, article of manufacture, method and/or computer program product embodiments, and/or combinations and sub-combinations thereof, for providing to a program or software a simulated current time that is substantially different from the real physical time.

In some embodiments, a computing device can include a system clock and a processor coupled to the system clock. The system clock can be configured to indicate a current time of the computing device that is approximately equal to a real physical time. A time adaption layer can be operated by the processor and include a time simulator to provide a simulated current time that is substantially different from the real physical time. A first program can be operated by the processor based on the current time provided by the system clock at the real physical time. In addition, a second program can be operated based on the simulated current time provided by the time simulator at the same real physical time.

In some embodiments, the simulated current time can be a past time or a future time of the current time indicated by the system clock. In some embodiments, the processor is a first processor, and the second program can be operated by a second processor coupled to the computing device by a communication link. In some embodiments, the simulated current time can be included in a header contained in a remote procedure call message sent from the time simulator to the second program.

In some embodiments, the real physical time can be a first real physical time, the current time indicated by the system clock can be a first current time, the simulated current time provided by the time simulator at the first real physical time can be a first simulated current time. At a second real physical time different from the first real physical time, the first program can be operated by the processor based on a second current time provided by the system clock at the second real physical time. In addition, the second program can be operated based on a second simulated current time provided by the time simulator at the second real physical time. In some embodiments, a system time difference between the first current time and the second current time can be substantially different from a simulated time difference between the first simulated current time and the second simulated current time. In some embodiments, the simulated time difference can be a multiple of the system time difference.

In some embodiments, the computing device can further include a task scheduler operated by the processor. The task scheduler can be configured to receive the simulated current time provided by the time simulator and further transmit the simulated current time to the second program. The task scheduler, the time simulator, and the time adaption layer can be operated by the processor of the computing device based on the current time provided by the system clock. In some embodiments, the task scheduler can be configured to pause the second program from accessing the simulated current time for a predetermined period of time. Accordingly, the second program can stop operations related to the simulated current time during the predetermined period of time. Furthermore, the task scheduler can be configured to resume the second program for accessing a simulated current time after the predetermined period of time lapses. Accordingly, the second program can perform operations related to the simulated current time after the predetermined period of time.

In some embodiments, a method can be performed by a computing device for providing to a program or software a simulated current time that is substantially different from the real physical time. The method can include generating, by a system clock, a current time of the computing device that is approximately equal to a real physical time. The method can further include providing, by the system clock, the current time to a first program operated by a processor of the computing device. Furthermore, the method can include generating, at the real physical time and by a time simulator of a time adaption layer operated by the processor, a simulated current time that is substantially different from the real physical time. Afterwards, the method can include providing, at the same real physical time, the simulated current time to a second program for the second program performing operations based on the simulated current time.

In some embodiments, a non-transitory computer-readable medium can store instructions that, when executed by a processor of a computing device, cause the computing device to perform various operations. In some embodiments, the operations can include generating, by a system clock, a current time of the computing device that is approximately equal to a real physical time. The method can further include providing, by the system clock, the current time to a first program operated by a processor of the computing device. Furthermore, the method can include generating, at the real physical time and by a time simulator of a time adaption layer operated by the processor, a simulated current time that is substantially different from the real physical time. Afterwards, the method can include providing, at the same real physical time, the simulated current time to a second program for the second program performing operations based on the simulated current time.

### BRIEF DESCRIPTION OF THE FIGURES

The accompanying drawings are incorporated herein and form a part of the specification.

FIGS. 1A-1C illustrate a block diagram of a computing system including multiple computing devices having a time adaption layer comprising a time simulator to provide a simulated current time provided to one or more programs, according to some embodiments.

FIGS. 2A-2B illustrate block diagrams of a task scheduler operated by a computing device to provide a current time or a simulated current time to one or more programs, according to some embodiments.

FIG. 3 illustrates a task scheduler performing a pause or resume operations related to accessing a simulated current time by a program, according to some example embodiments.

FIG. 4 illustrates a sequence diagram presenting the events for providing a simulated current time to one or more programs, according to some example embodiments.

FIG. 5 is a flowchart illustrating an example process for providing a simulated current time to one or more programs, according to some embodiments.

FIG. 6 illustrates an example computing system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for providing to a program or software a simulated current time that is substantially different from the real physical time or a current time of the computing device indicated by a system clock. Accordingly, the program can simulate the system behavior in a simulated current time that is at a past time or a future time of the current time indicated by the system clock.

A system clock of a computing device can enable various circuits or hardware components inside the computing device to work together at the same time. When software performs operations related to a current time of the computing device, the software can read the current time from the system clock. A current time provided by a system clock can be approximately equal to a real physical time (i.e. a true time), which can be measured by a time standard such as the atomic time standard, the ephemeris time standard, or other time standards. However, there can be a difference between a system clock of a computing device and the real physical time due to clock drift or any other physical causes. In some embodiments, a difference between a system clock of a computing device and the real physical time can be in a range of approximately 10-5 second. In some embodiments, a difference between a system clock of a computing device and the real physical time can be in a range understood by one having the ordinary skills in the art.

In some embodiments, in addition to the difference between a current time indicated by a system clock and the real physical time, there can be other issues for the current time provided to a software system by the system clock. When multiple computing devices or computers are involved in executing a software function, multiple system clocks of multiple computing devices can be involved, such as in a distributed system. The multiple system clocks of multiple computing devices cannot be exactly synchronized, leading to inconsistency among them. Furthermore, the current time provided by the system clock is approximately equal to the real physical time, hence cannot be substantially different from the real physical time. Accordingly, the current time provided by the system clock cannot be a time that is substantially in the past time or future time of the real physical time or the current time indicated by the system clock. In some cases, a system clock can be adjusted to be off synchronization with the real physical time. However, a computing device can operate multiple programs concurrently, some of which may use a current time approximately equal to the real physical time. Accordingly, adjusting the system clock of a computing device to be off synchronization with the real physical time can affect all programs operated by the computing device, which can lead to chaos to some programs that use a current time approximately equal to the real physical time.

In developing a software system or program, it is important to test or simulate the behavior of the software system or program to meet the desired system performances and the intended functions. However, some software systems or programs can perform operations in a long life cycle. For example, in the financial industry, many financial products may need the passage of a long time period to render a full lifecycle of the financial products. A user can apply for a credit card, and then start paying the fees charged to the credit card in installments overtime. Such a credit card product or service can expand for multiple months or years. When testing a complex software system such as the software for managing the credit card service, any behavior that unfolds over an extended period of time can be difficult and expensive to simulate and test accurately. Operations based on the current time indicated by a system clock cannot simulate functionality that has occurred in the past or will occur in the future of the current time indicated by the system clock. Accordingly, testing a software system for a credit card service can expand months or years to test the full functionality, which can be a challenge for the engineering team and costly for the company as well.

Embodiments herein present a framework using a time adaption layer operated by a computing device to speed up the testing or simulation of a software system. A time simulator within the time adaption layer can provide a simulated current time that is substantially different from the real physical time, and hence substantially different from the current time provided by a system clock of the computing device. The time simulator can provide the simulated current time to a program or software system that uses the simulated current time to perform operations in a past time or a future time of the current time indicated by the system clock. At the meantime, the computing device can operate another program based on the current time provided by the system clock at the real physical time. Therefore, the time adaptor layer can effectively and seamlessly integrate systems that use time as the time passes in the physical world and the systems using time that is compressed or dilated. As a result, the framework presented herein based on the time adaptor layer can be referred to as a “time dilation framework” or a “time adaption framework.”

In some embodiments, the time adaption layer or the time simulator can limit or reduce the impact or intrusion of a simulated current time to the rest of the system functionality. In addition, the simulated current time can be provided by the time simulator across multiple programs without requiring extra code to be written for each program. Therefore, the simulated current time provided by the time simulator can be integrated into software for scheduling tasks for future execution to simulate the passage of time in an expedited way. As a result, techniques presented herein can enable the systems to execute a month's worth of business logic in matter of minutes and hence greatly accelerate the testing timelines for a complex software system. For the descriptions herein, a software system, software, or a program are used interchangeable to refer to any software system operated by a processor or a hardware component.

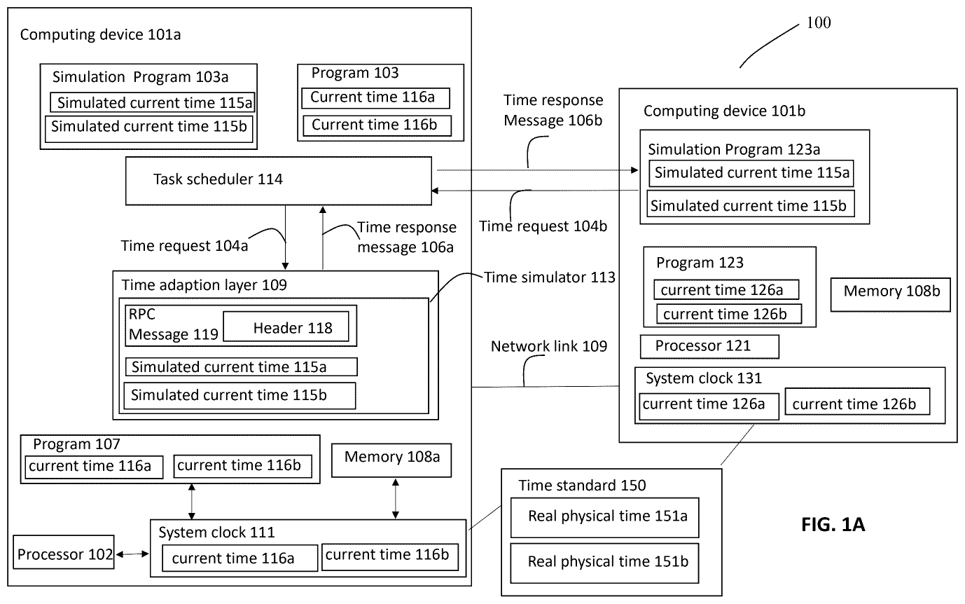

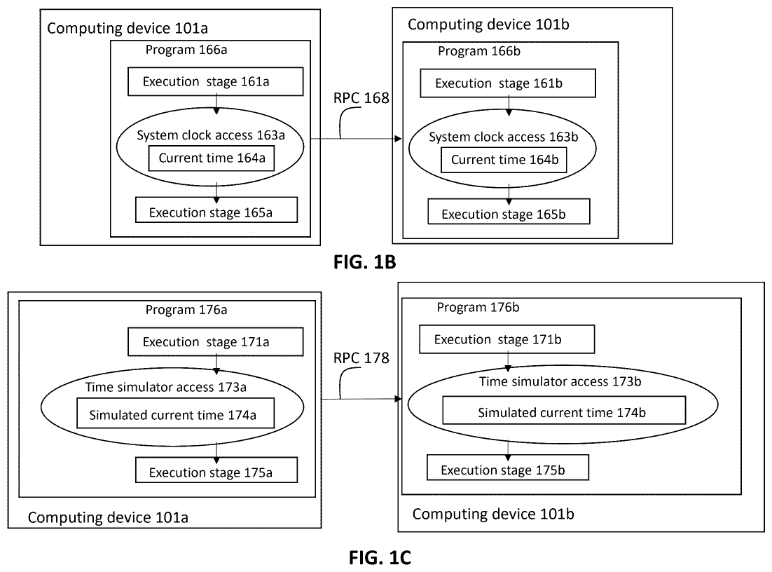

FIGS. 1A-1C illustrate a block diagram of a computing system 100 including multiple computing devices having a time adaption layer comprising a time simulator to provide a simulated current time provided to one or more programs, according to some embodiments. Computing system 100 can include a computing device 101a and a computing device 101b. There can be other number of computing devices with computing system 100, such as only one computing device or more than two computing devices.

In some embodiments, computing device 101a can include a system clock 111, a memory device 108a, and a processor 102 coupled to system clock 111 and memory device 108a. Similarly, computing device 101b can include a system clock 131, a memory device 108b, and a processor 121 coupled to system clock 131 and memory device 108b. Computing device 101a can be coupled to computing device 101b by a network link 109. In addition, a memory device can include various programs. In some embodiments, memory device 108a can include a program 107, a program 103, a simulation program 103a, task scheduler 114, and/or time adaption layer 109, which can be operated by processor 102. Memory device 108b can include a program 123 and a simulation program 123a.

In some embodiments, a system clock can be configured to indicate a current time of a computing device that is approximately equal to a real physical time. System clock 111 can indicate a current time 116a at a real physical time 151a that is approximately equal to current time 116a, and can further indicate a current time 116b at a real physical time 151b that is approximately equal to current time 116b. System clock 131 can indicate a current time 126a at real physical time 151a that is approximately equal to current time 126a, and can further indicate a current time 126b at real physical time 151b that is approximately equal to current time 126b. In addition, current time 126a indicated by system clock 131 can be different from current time 116a indicated by system clock 111 when system clock 111 is not synchronized with system clock 131. Since both are approximately equal to real physical time 151a, current time 126a can be approximately equal to current time 116a, while current time 126b can be approximately equal to current time 116b.

In some embodiments, real physical time 151a or real physical time 151b can be defined by a time standard 150 such as the atomic time standard. In some embodiments, a time standard can be a specification for measuring time: either the rate at which time passes or points in time or both. Several time specifications have been officially recognized as standards, where formerly they were matters of custom and practice. An example of a kind of time standard can be a time scale, specifying a method for measuring divisions of time. There can be a difference between a system clock of a computing device and the real physical time due to clock drift or any other physical causes. In some embodiments, a difference between a system clock of a computing device and the real physical time can be in a range of approximately 10-5 second. In some embodiments, a difference between a system clock of a computing device and the real physical time can be in a range understood by one having the ordinary skills in the art.

In some embodiments, a time adaption layer 109 can be operated by processor 102 and can include a time simulator 113 to provide a simulated current time that is substantially different from the real physical time, which can be substantially beyond the range of the real physical time caused by the physical environment of a system clock. Accordingly, at real physical time 151a, time simulator 113 can provide a simulated current time 115a that is substantially different from real physical time 151a, and hence substantially different from current time 116a. Similarly, at real physical time 151b, time simulator 113 can provide a simulated current time 115b that is substantially different from real physical time 151b, and hence substantially different from current time 116b. In some embodiments, simulated current time 115a can be a past time or a future time of real physical time 151a or current time 116a indicated by system clock 111.

In some embodiments, a system time difference between current time 116a and current time 116b can be substantially different from a simulated time difference between simulated current time 115a and simulated current time 115b. In some embodiments, the simulated time difference can be a multiple of the system time difference. For example, a system time difference between current time 116a and current time 116b can be a minute, while a simulated time difference between simulated current time 115a and simulated current time 115b can be a year.

In some embodiments, a program 107 can be operated by processor 102 of computing device 101a based on current time 116a provided by system clock 111 at real physical time 151a, and based on current time 116b provided by system clock 111 at real physical time 151b. Similarly, a program 103 can be operated by processor 102 based on current time 116a provided by system clock 111 at real physical time 151a, and based on current time 116b provided by system clock 111 at real physical time 151b. A program 123 can be operated by processor 121 of computing device 101b based on current time 126a provided by system clock 131 at real physical time 151a, and based on current time 126b provided by system clock 131 at real physical time 151b.

In some embodiments, a program 103a, which can be a simulation program, can be operated based on the simulated current time provided by the time simulator at the same real physical time. Simulation program 103a can be operated based on simulated current time 115a provided by time simulator 113 at real physical time 151a, and operated based on simulated current time 115b provided by time simulator 113 at real physical time 151b. Similarly, a simulation program 123a can be operated based on simulated current time 115a provided by time simulator 113 at real physical time 151a, and operated based on simulated current time 115b provided by time simulator 113 at real physical time 151b. Even though simulation program 103a and simulation program 123a are operated on two different computing device having two different system clocks, simulation program 103a and simulation program 123a can access the same simulated current times provided by time simulator 113.

In some embodiments, simulated current time 115a or simulated current time 115b can be included in a header 118 contained in a remote procedure call (RPC) message 119 sent from time simulator 113 to simulation program 123a or simulation program 103a. In some embodiments, simulation program 123a can send a time request 104b to computing device 101a and receive a time response message 106b that includes RPC message 119 and header 118.

In some embodiments, program 103 and program 123 can be a part of a system based on physical time (SBPT) that represents any system that handles the passage of time as it takes place in the real word (e.g., 1 minute on these systems equals 1 minute in the physical world). A SBPT system can be a software system serving real customer or system needs. Program 103a and program 123a can be a part of a system on dilated time (SBDT) that represents any system or collection of systems that handles the passage of time in a dilated or compressed way (e.g., 1 month in these systems could equal 1 day in the physical world). Accordingly, during one day of the real physical world, business logic of about one month can happen in the SBDT system. A SBDT system is a simulation system of a SBPT system to simulate the functions and performance of the SBPT system. In addition, time adaption layer 109 and time simulator 113 can form a time adaption or dilation framework that represents the layer of functionality that enables a seamless interaction between a SBPT system and a SBDT system. In some embodiments, time adaption layer 109 and time simulator 113 can be merged into one entity, where functions of time simulator 113 can be performed by time adaption layer 109. In some embodiments, the SBPT system can include only one program or multiple programs operated by one computing device. For example, program 103 operated by computing device 101a can form the SBPT system.

In some embodiments, computing device 101a can further include a task scheduler 114 operated by processor 102. Task scheduler 114 can be configured to receive simulated current time 115a or 115b provided by time simulator 113 and further transmit simulated current time 115a or 115b to simulation program 103a or 123a. Task scheduler 114 can send a time request message 104a to time simulator 113 and receive a time response message 106a from time simulator 113. In some embodiments, time response message 106a can include RPC message 119 and header 118, where header 118 can include simulated current time 115a or simulated current time 115b. In some embodiments, task scheduler 114, time simulator 113, and time adaption layer 109 can be operated by processor 102 of computing device 101a based on the current time provided by system clock 111.

In some embodiments, task scheduler 114 can be configured to pause simulation program 103a or 123a from accessing simulated current time 115a or 115b for a predetermined period of time. Accordingly, simulation program 103a or 123a can stop operations related to simulated current time 115a or 115b during the predetermined period of time. Furthermore, task scheduler 114 can be configured to resume simulation program 103a or 123a for accessing simulated current time 115a or 115b after the predetermined period of time lapses. Accordingly, simulation program 103a or 123a can perform operations related to simulated current time 115a or 115b after the predetermined period of time.

In some embodiments, computing device 101a or 101b can be a stationary or mobile device. For example, computing device 101a or 101b can be a cellular phone (e.g., a smart phone), a personal digital assistant (PDA), a handheld device, a laptop, a desktop, a cordless phone, a wireless local loop station, a tablet, a camera, a gaming device, a netbook, an ultrabook, a medical device or equipment, a biometric sensor or device, a wearable device (smart watch, smart clothing, smart glasses, smart wrist band, smart jewelry such as smart ring or smart bracelet), an entertainment device (e.g., a music or video device, or a satellite radio), a vehicular component, a smart meter, an industrial manufacturing equipment, a global positioning system device, an Internet-of-Things (IoT) device, a machine-type communication (MTC) device, an evolved or enhanced machine-type communication (eMTC) device, or any other suitable device that is configured to perform computation as described herein.

In some embodiments, communication link 109 can include a wired or wireless communication connection of a communication system. In some embodiments, communication link 109 can include multiple segments of links, and one segment can be a wireless link going through a fixed station or a mobile station. For example, communication link 109 can include a wireless communication connection from a base transceiver system (BTS), an access point (AP), a transmission/reception point (TRP), an evolved NodeB (eNB), a next generation node B (gNB), a 5G node B (NB), or some other equivalent terminology. In some embodiments, communication link 109 can be in a wireless Local Area Networks (LAN), wireless Metropolitan Area Networks (MAN), wireless Wide Area Networks (WAN), wireless Personal Area Networks (PAN), wireless sensor networks, satellite communication networks, or thread networks.

In some embodiments, processor 102 or processor 121 can be a general processor, a network processor, a security processor, a graphics processing unit (GPU), an application specific processor, or any other processing device known to one having the ordinary skills in the art as a processor. In some embodiments, computing device 101a or 101b can include multiple processors, where processor 102 or processor 121 is an example of the multiple processors.

FIG. 1B illustrates the execution of programs based on a current time of the computing device indicated by a system clock that is approximately or substantially equal to a real physical time.

In some embodiments, program 166a can be operated by processor 102 of computing device 101a. At a first real physical time, program 166a can be at an execution stage 161a, and access the system clock at operation 163a to retrieve a current time 164a indicated by the system clock of computing device 101a. Based on the retrieved current time 164a, at a second real physical time, program 166a can perform operations at execution stage 165a. Similarly, a program 166b can be operated by processor 121 of computing device 101b. At the first real physical time, program 166b can be at an execution stage 161b, and access the system clock at operation 163b to retrieve a current time 164b indicated by the system clock of computing device 101b. Based on the retrieved current time 164b, at the second real physical time, program 166b can perform operations at execution stage 165b. In some embodiments, a RPC message 168 can be transmitted from program 166a to program 166b through a communication link between computing device 101a and computing device 101b. In some embodiments, RPC message 168 can be a way for program 166a to invoke functionality provided by program 166b. In some embodiments, RPC message 168 can include a header that contains a secondary piece of data that is intended for more generalized purposes related to the communication rather than invoking direct functionality of program 166b.

In some embodiments, FIG. 1C illustrates the execution of programs based on a simulated current time provided by a time simulator of a time adaption layer. In some embodiments, the simulated current time can be substantially different from the real physical time.

In some embodiments, program 176a can be operated by processor 102 of computing device 101a. At a first real physical time, program 176a can be at an execution stage 171a, and access the time simulator at operation 173a to retrieve a simulated current time 174a indicated by the time simulator of computing device 101a. Based on the retrieved simulated current time 174a, at a second real physical time, program 176a can perform operations at execution stage 175a. Similarly, a program 176b can be operated by processor 121 of computing device 101b. At a first real physical time, program 176b can be at an execution stage 171b, and access the time simulator of computing device 101b at operation 173b to retrieve a simulated current time 174b indicated by the time simulator of computing device 101b. Based on the retrieved simulated current time 174b, at a second real physical time, program 176b can perform operations at execution stage 175b. In some embodiments, a RPC message 178 can be transmitted from program 176a to program 176b through a communication link between computing device 101a and computing device 101b. In some embodiments, RPC message 178 can be a way for program 176a to invoke functionality provided by program 176b. In some embodiments, RPC message 178 can include a header that contains simulated current time 174a sent from computing device 101a to computing device 101b to become simulated current time 174b.

In some embodiments, at a real physical time Jun. 4, 2024 at 1:37 pm Eastern Standard Time, program 176a can retrieve a simulated current time 174a, which can be a past time, e.g., Feb. 7, 2022, 1:37 PM Eastern Standard Time. In addition, simulated current time 174a (Feb. 7, 2022, 1:37 PM Eastern Standard Time) can be sent within the header of RPC message 178 to be sent to program 176b. Accordingly, program 176b can simulate the system behavior at Feb. 7, 2022, 1:37 PM Eastern Standard Time without any other program changes needed. Therefore, by using the simulated current time 174a, program 176a can operate at a time that is substantially different from the real physical time.

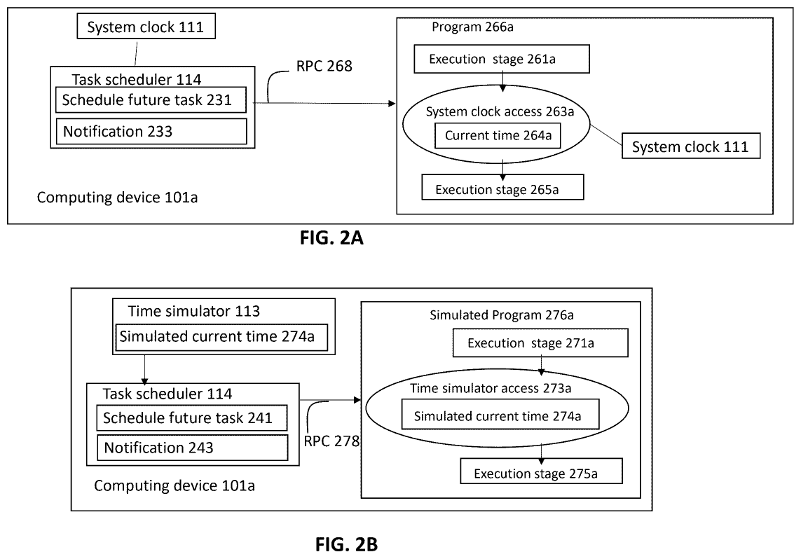

FIGS. 2A-2B illustrate block diagrams of a task scheduler operated by a computing device to provide a current time or a simulated current time to one or more programs, according to some embodiments.

In some embodiments, a program can be scheduled to execute a task at a time in the future or simulate the execution of a task that happened at a time in the past. Task schedule 114 of computing device 101a can be an independent program whose job is to schedule and notify a separate program to execute a task at some point in time as shown in FIGS. 2A-2B.

In some embodiments, task schedule 114 can schedule a future task 231 for a program 266a. Based on a current time indicated by system clock 111 of computing device 101a, task schedule 114 can generate a notification 233 to be sent to program 266a to execute the scheduled task. Notification 233 can be sent by a RPC message 268.

In some embodiments, program 266a can be operated by processor 102 of computing device 101a. At a first real physical time, program 266a can be at an execution stage 261a. At operation 263a, program 266a can access a current time 264a provided by system clock 111 of computing device 101a. Since current time 264a can be provided by system clock 111, RPC message 268 may not include current time 264a as a part of the message. Based on current time 264a, at a second real physical time, program 266a can perform operations at execution stage 265a.

In some embodiments, task schedule 114 can schedule a future task 241 for a simulated program 276a. Based on a simulated current time 274a provided by time simulator 113 of computing device 101a, task schedule 114 can generate a notification 243 to be sent to simulated program 276a to execute the scheduled task. Notification 243 can be sent by a RPC message 278. In some embodiments, simulated current time 274a can be included in the header of RPC message 278 to be sent from task schedule 114 to simulated program 276a.

In some embodiments, simulated program 276a can be operated by processor 102 of computing device 101a. At a first real physical time, program 276a can be at an execution stage 271a, and access simulated current time 274a transmitted by RPC message 278 at time simulator access operation 273a. Based on simulated current time 274a received from task schedule 114, at a second real physical time, simulated program 276a can perform operations at execution stage 275a.

In some embodiments, since simulated current time 274a is provided to task schedule 114 by time simulator 113, the actual time or the real physical time doesn't need to pass during the simulation at the same pace as simulated current time 274a. Instead, task scheduler 114 can use the incoming headers of a RPC message from time simulator 113 to compute or derive simulated current time 274a. Furthermore, task scheduler 114 can transmit simulated current time 274a to simulated program 276a.

In some embodiments, time simulator 113 can shrink a one year timeline with 1 state change per day in the real physical world according to system clock 111 into a 365 second timeline with 1 state change per second according to simulated current time 274a.

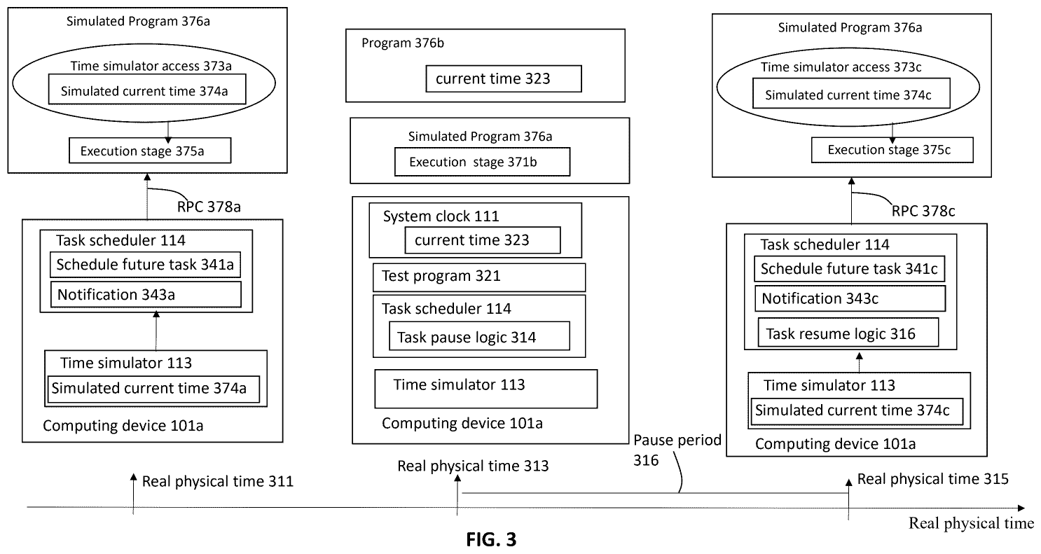

FIG. 3 illustrates task scheduler 114 performing a pause or resume operations related to accessing a simulated current time by a program, according to some example embodiments.

In some embodiments, the real physical time moves along an axis following a direction from left to the right, where a real physical time 311 as an earliest time is followed by a real physical time 313, and further followed by a real physical time 315.

In some embodiments, at real physical time 311, task schedule 114 can schedule a future task 341a for a simulated program 376a. Based on a simulated current time 374a provided by time simulator 113 of computing device 101a, task schedule 114 can generate a notification 343a to be sent to simulated program 376a to execute the scheduled task. Notification 343a can be sent by a RPC message 378a.

In some embodiments, at real physical time 311, simulated program 376a can be operated by processor 102 of computing device 101a. At time simulator access operation 373a, simulated program 376a can access simulated current time 374a from time simulator 113 transmitted by RPC message 378a. Based on simulated current time 374a received from task schedule 114, simulated program 376a can perform operations at execution stage 375a.

In some embodiments, at real physical time 313, task scheduler 114 can pause simulated program 376a from accessing the simulated current time provided by time simulator 113 for a predetermined period of time 316, which can be referred to as pause period 316. During pause period 316, simulated program 376a can stop operations related to the simulated current time. However, simulated program 376a can still perform operations at execution stage 371b for operations not related to the simulated current time.

In some embodiments, simulated program 376a is to simulate the operations of program 376b, where simulated program 376a and program 376b have the same system behavior, functions, and performance. Program 376b operates under current time 323 provided by system clock 111, while simulated program 376a operates under simulated current time 374a provided by time simulator 113. Time simulator 113 can help to exercise that logic of simulated program 376a at a controlled rate relative to real world time.

In some embodiments, task scheduler 114 can include a task pause logic 314 that can perform operations to pause simulated program 376a from accessing the simulated current time. While simulated program 376a is paused from performing operations related to the simulated current time, a test program 321 can perform operations to deterministically validate that the state of simulated program 376a can match the intended state of program 376b. By allowing simulated program 376a to pause the execution flow at a time, test program 321 can validate expected program state before allowing simulated program 376a to continue running at the accelerated rate.

In some embodiments, task scheduler 114 can include task resume logic 316. At real physical time 315 after pause period 316, task resume logic 316 of task scheduler 114 can allow simulated program 376a to resume accessing a simulated current time 374c provided by time simulator 113. Task schedule 114 can schedule a future task 341c for simulated program 376a. Based on simulated current time 374c provided by time simulator 113, task schedule 114 can generate a notification 343c to be sent to simulated program 376a to execute the scheduled task. Notification 343a can be sent by a RPC message 378c. In addition, at real physical time 315, simulated program 376a can access simulated current time 374c during time simulator access operation 373c, and further perform operations at execution stage 375c.

In some embodiments, during pause period 316, task scheduler 114 can consume a separate stream of messages sent from test program 321. This message stream allows task scheduler 114 to opportunistically send out notifications for scheduled tasks associated with a test scenario. The usage of test scenarios explicitly allows multiple simulated times to exist within a program at the same time. Accordingly, different tests can operate in the same environment, allowing them to independently run at different simulated times, while also pausing and resuming at different times as well.

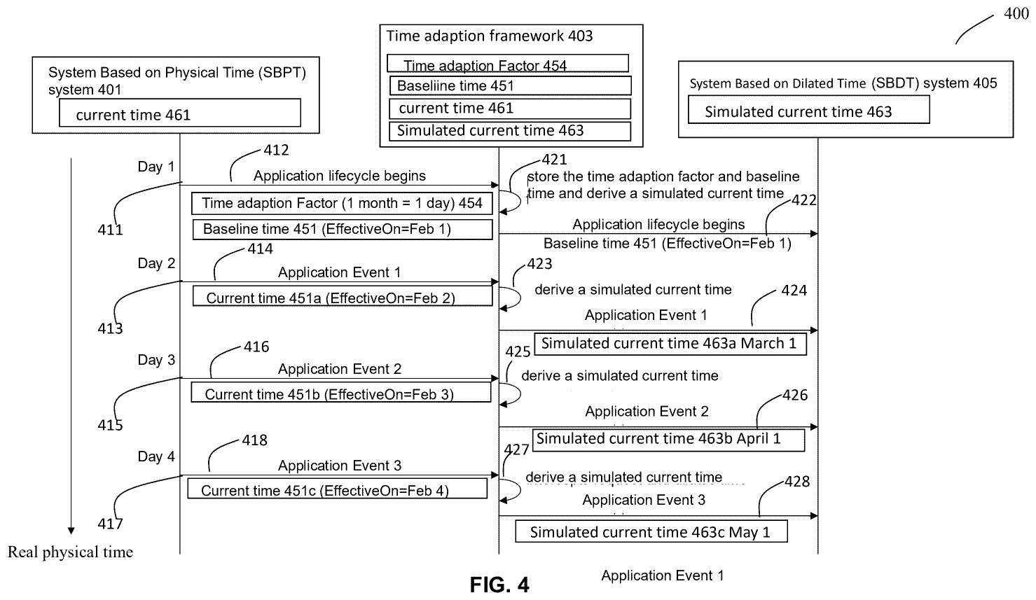

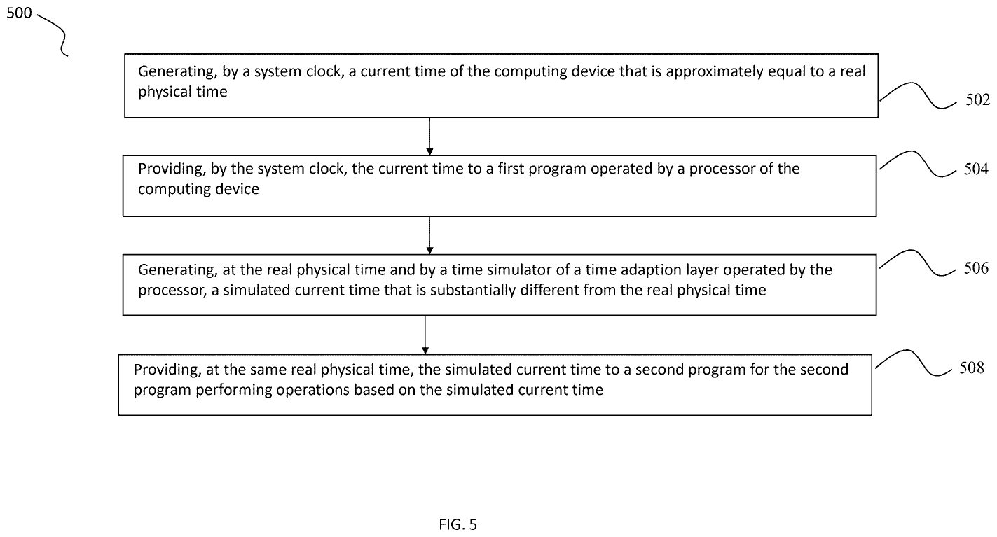

FIG. 4 illustrates a sequence diagram 400 presenting the events for providing a simulated current time to one or more programs in computing system 100, according to some example embodiments.

In some embodiments, a SBPT system 401 can communicate with a time adaption framework 403, which can communicate with a SBDT system 405. In some embodiments, SBPT system 401 can include program 103 and/or program 123, and SBDT system 405 can include program 103a and/or program 123a as shown in FIG. 1A. In some embodiments, SBPT system 401 can represent any system that handles the passage of time as it takes place in the real word (e.g., 1 minute on SBPT system 401 equals 1 minute in the physical world). In some embodiments, SBDT system 405 can represent any system or collection of systems that handles the passage of time in a dilated or compressed way (e.g., events of 1 month in SBDT system 405 can take place in 1 day in the physical world). In some embodiments, time adaption framework 403 can include time adaption layer 109 and time simulator 113, which can represent the layer of functionality that enables a seamless interaction between SBPT system 401 and SBDT system 405.

In some embodiments, SBPT system 401 can operate based on a current time 461 indicated by a system clock that is substantially or approximately equal to a real physical time. Time adaption framework 403 can operate based on current time 461 indicated by the system clock, and further convert current time 461 into a simulated current time 463. In addition, time adaption framework 403 can store a baseline time 451 representing a starting moment when SBDT system 405 starts to simulate the events in SBPT system 401. In some embodiments, at baseline time 451, simulated current time 463 can be the same as current time 461 indicated by the system clock of SBPT system 401.

In some embodiments, at operation 411, SBPT system 401 can invoke SBDT system 405 by sending a request message 412 to time adaption framework 403. Request message 412 can indicate an application life cycle starts for SBDT system 405. A header of request message 412 can include a parameter “time adaption factor” 454, which can represent that a current time in SBPT system 401 can be expanded or compressed in SBDT system 405 by the time adaption factor. For example, a one day in SBPT system 401, which can be referred to as physical time (PT), can be expanded or dilated into one month, which can be referred to as a dilated time (DT), as indicated by time dilation factor 454. Accordingly, business events happening in one month in SBDT system 405 can be executed in one day in SBPT system 401. In addition, request message 412 can include baseline time 451, which can be a current time at the real physical time for operation 411.

In some embodiments, at operation 421, time adaption framework 403 can receive request message 412 from SBPT system 401 and store time adaption factor 454 and baseline time 451 included in the header of request message 412. Time adaption factor 454 and baseline time 451 can be used to derive simulated current time 463. At the real physical time for operation 411, simulated current time 463 can be the same as baseline time 451 to indicate a starting moment for SBDT system 405.

In some embodiments, at operation 422, time adaption framework 403 can forward simulated current time 463 equal to baseline time 451 to be processed by SBDT system 405. In some embodiments, baseline time 451 can be February 1^{st}. Upon receiving baseline time 451 or simulated current time 463, SBDT system 405 can store baseline time 451 or simulated current time 463, and further starts the lifecycle of simulation for SBPT system 401.

In some embodiments, at operation 413, SBPT system 401 can send an application event 414 to SBDT system 405 according to its own schedule. In some embodiments, operation 413 can happen at day 2 of the operations while operation 411 can happen at day 1. Accordingly, application event 414 can indicate a current time 451a, which can have a value of February 2^{nd}. At operation 423, time adaption framework 403 can receive current time 451a, and further derive a simulated current time 463a based on time adaption factor 454 and baseline time 451.

In some embodiments, time adaption framework 403 can derive simulated current time 463a based on a formula: simulated current time 463a=baseline time 451+(current time 451a−baseline time 451)*time adaption factor 454. In other words, simulated current time 463a can be calculated based on the formulas-dilation duration = (current time 451a−baseline time 451)*time adaption factor 454, and current time 463a=baseline time 451+dilation duration. For example, for application event 414 sent at operation 413, simulated current time 463a =Feb 1+(February 2−February 1)*30=March 1. In some embodiments, at operation 424, time adaption framework 403 can forward application event 414 and simulated current time 463a to SBDT system 405. Afterwards, SBDT system 405 can perform operations based on simulated current time 463a and data about application event 414. SBDT system 405 can perform operations based on business logic designed for simulated current time 463a, which is March 1^{st}. Hence, SBDT system 405 can simulate the operations and business logic of SBPT system 401 at a future time of the real physical time for SBPT system 401.

In some embodiments, time adaption framework 403 can receive baseline time 451, time adaption factor 454, and current time 451a to derive simulated current time 463a. In some embodiments, time adaption framework 403 can detect the header of request message 412 to receive baseline time 451 and time adaption factor 454. In some embodiments, baseline time 451 can be sent at one time only through the entire testing journey that can be explicitly set by SBPT system 401. In some embodiments, baseline time 451 can be implicitly inferred from business context, which can be agreed beforehand between SBPT system 401, time adaption framework 403, and SBDT system 405.

In some embodiments, time adaption framework 403 can store and maintain baseline time 451 for each test scenario and retrieve the parameter for each interaction. With subsequent requests from SBPT system 401, time adaption framework 403 can convert a current time of SBPT system 401 to a simulated current time for SBDT system 405 based on baseline time 451 and time adaption factor 454. In some embodiments, the real physical time can be dilated by time adaption framework 403 based on calculating the time difference between the baseline time 451 and the current physical time, e.g., current time 451a. Afterwards, time adaption framework 403 can multiply the time difference between the baseline time 451 and the current physical time by time adaption factor 454 to obtain simulated current time 463a. Accordingly, simulated current time 463a can be propagated through the entire SBDT system 405 as the simulated physical time going forward. Accordingly, time adaption framework 403 can operate on a dedicated and separated layer from SBPT system 401 and SBDT system 405. In addition, time adaption framework 403 can allow configuration on a per application programming interface (API) basis, configuring it to be enabled or disabled by various testing needs.

In some embodiments, the same process including operation 413 to operation 424 can be applied for additional operations and application events included in a request sent by SBPT system 401. Time adaption framework 403 can be responsible and capable of detecting all time components and applying the same formula shown above to transform the current time included in the request from SBPT system 401 to a simulated current time.

In some embodiments, at operation 415, SBPT system 401 can send an application event 416 to SBDT system 405. In some embodiments, operation 415 can happen at day 3 of the operations. Accordingly, application event 416 can indicate a current time 451b, which can have a value of February 3rd. At operation 425, time adaption framework 403 can receive current time 451b and further derive a simulated current time 463b based on current time 451b, time adaption factor 454, and baseline time 451.

In some embodiments, time adaption framework 403 can derive simulated current time 463b based on the formula: simulated current time 463b =baseline time 451+(current time 451b−baseline time 451)*time adaption factor 454. For application event 416 sent at operation 415, simulated current time 463b=Feb 1+(February 3−February 1)*30=April 1. In some embodiments, at operation 426, time adaption framework 403 can forward application event 416 and simulated current time 463b to SBDT system 405. Afterwards, SBDT system 405 can perform operations based on simulated current time 463b and data about application event 416. SBDT system 405 can perform operations based on business logic designed for simulated current time 463b, which is April 1^{st}. At the same real physical time, SBPT system 401 has a current time of February 3^{rd}.

In some embodiments, at operation 417, SBPT system 401 can send an application event 418 to SBDT system 405. In some embodiments, operation 417 can happen at day 4 of the operations. Accordingly, application event 418 can indicate a current time 451c, which can have a value of February 4th. At operation 427, time adaption framework 403 can receive current time 451c, and further derive a simulated current time 463c based on current time 451c, time adaption factor 454, and baseline time 451.

In some embodiments, time adaption framework 403 can derive simulated current time 463c based on a formula: simulated current time 463c =baseline time 451+(current time 451c−baseline time 451)*time adaption factor 454. For application event 418 sent at operation 417, simulated current time 463c=Feb 1+(February 4−February 1)*30=May 1. In some embodiments, at operation 428, time adaption framework 403 can forward application event 418 and simulated current time 463c to SBDT system 405. Afterwards, SBDT system 405 can perform operations based on simulated current time 463c and data about application event 418. SBDT system 405 can perform operations based on business logic designed for simulated current time 463a, which is May 1st.

In some embodiments, based on time adaption framework 403, SBDT system 405 can test behavior across a heterogeneous sets of systems, e.g., SBPT system 401, in a matter of minutes or days, which would have otherwise taken weeks or months. Accordingly, embodiments herein can achieved dramatic savings on testing time.

FIG. 5 is a flowchart illustrating an example process 500 for providing a simulated current time to one or more programs, according to some embodiments. In some embodiments, process 500 can be performed by computing device 101a as shown in FIG. 1.

In some embodiments, at operation 502, system clock 111 can generate current time 116a of computing device 101a that is approximately equal to real physical time 151a.

In some embodiments, at operation 504, system clock 111 can provide current time 116a to program 103 operated by processor 102 of computing device 101a.

In some embodiments, at operation 506, at the real physical time 151a, time simulator 113 of time adaption layer 109 can generate simulated current time 115a that is substantially different from real physical time 151a.

In some embodiments, at operation 508, at the real physical time 151a, time simulator 113 can provide simulated current time 115a to program 103a for program 103a performing operations based on simulated current time 115a.

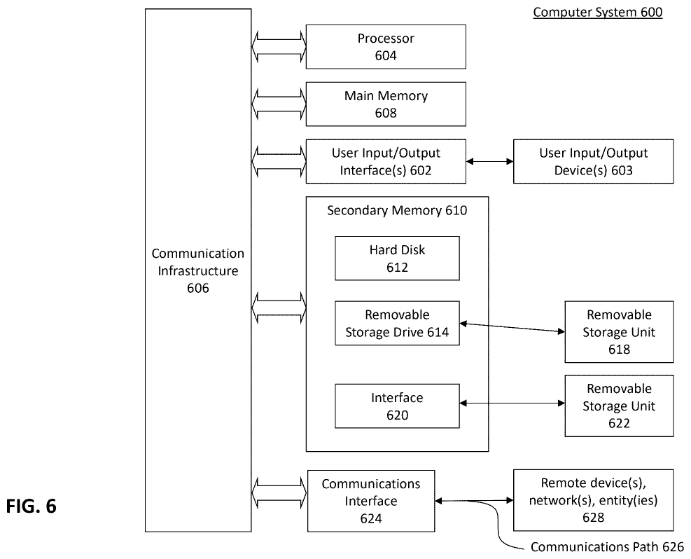

Various aspects can be implemented, for example, using one or more computer systems, such as computer system 600 shown in FIG. 6. Computer system 600 can be any computer capable of performing the functions described herein such as computing device 101a and computing device 101b as shown in FIGS. 1A-1C, for operations described for process 400 and process 500 as shown in FIGS. 4-5. Computer system 600 includes one or more processors (also called central processing units, or CPUs), such as a processor 604. Processor 604 is connected to a communication infrastructure 606 (e.g., a bus). Computer system 600 also includes user input/output device(s) 603, such as monitors, keyboards, pointing devices, etc., that communicate with communication infrastructure 606 through user input/output interface(s) 602. Computer system 600 also includes a main or primary memory 608, such as random access memory (RAM). Main memory 608 may include one or more levels of cache. Main memory 608 has stored therein control logic (e.g., computer software) and/or data.

Computer system 600 may also include one or more secondary storage devices or memory 610. Secondary memory 610 may include, for example, a hard disk drive 612 and/or a removable storage device or drive 614. Removable storage drive 614 may be a floppy disk drive, a magnetic tape drive, a compact disk drive, an optical storage device, tape backup device, and/or any other storage device/drive.

Removable storage drive 614 may interact with a removable storage unit 618. Removable storage unit 618 includes a computer usable or readable storage device having stored thereon computer software (control logic) and/or data. Removable storage unit 618 may be a floppy disk, magnetic tape, compact disk, DVD, optical storage disk, and/any other computer data storage device. Removable storage drive 614 reads from and/or writes to removable storage unit 618 in a well-known manner.

According to some aspects, secondary memory 610 may include other means, instrumentalities or other approaches for allowing computer programs and/or other instructions and/or data to be accessed by computer system 600. Such means, instrumentalities or other approaches may include, for example, a removable storage unit 622 and an interface 620. Examples of the removable storage unit 622 and the interface 620 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

In some examples, main memory 608, the removable storage unit 618, the removable storage unit 622 can store instructions that, when executed by processor 604, cause processor 604 to perform operations by computing device 101a and computing device 101b as shown in FIGS. 1A-1C, for operations described for process 400 and process 500 as shown in FIGS. 4-5.

Computer system 600 may further include a communication or network interface 624. Communication interface 624 enables computer system 600 to communicate and interact with any combination of remote devices, remote networks, remote entities, etc. (individually and collectively referenced by reference number 628). For example, communication interface 624 may allow computer system 600 to communicate with remote devices 628 over communications path 626, which may be wired and/or wireless, and which may include any combination of LANs, WANs, the Internet, etc. Control logic and/or data may be transmitted to and from computer system 600 via communication path 626. Operations of the communication interface 624 can be performed by a wireless controller, and/or a cellular controller. The cellular controller can be a separate controller to manage communications according to a different wireless communication technology. The operations in the preceding aspects can be implemented in a wide variety of configurations and architectures. Therefore, some or all of the operations in the preceding aspects may be performed in hardware, in software or both. In some aspects, a tangible, non-transitory apparatus or article of manufacture includes a tangible, non-transitory computer useable or readable medium having control logic (software) stored thereon is also referred to herein as a computer program product or program storage device. This includes, but is not limited to, computer system 600, main memory 608, secondary memory 610 and removable storage units 618 and 622, as well as tangible articles of manufacture embodying any combination of the foregoing. Such control logic, when executed by one or more data processing devices (such as computer system 600), causes such data processing devices to operate as described herein.

Based on the teachings contained in this disclosure, it will be apparent to persons skilled in the relevant art(s) how to make and use aspects of the disclosure using data processing devices, computer systems and/or computer architectures other than that shown in FIG. 6. In particular, aspects may operate with software, hardware, and/or operating system implementations other than those described herein.

It is to be appreciated that the Detailed Description section, and not the Summary and Abstract sections, is intended to be used to interpret the claims. The Summary and Abstract sections may set forth one or more, but not all, exemplary aspects of the disclosure as contemplated by the inventor(s), and thus, are not intended to limit the disclosure or the appended claims in any way.

While the disclosure has been described herein with reference to exemplary aspects for exemplary fields and applications, it should be understood that the disclosure is not limited thereto. Other aspects and modifications thereto are possible, and are within the scope and spirit of the disclosure. For example, and without limiting the generality of this paragraph, aspects are not limited to the software, hardware, firmware, and/or entities illustrated in the figures and/or described herein. Further, aspects (whether or not explicitly described herein) have significant utility to fields and applications beyond the examples described herein.

Aspects have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. In addition, alternative aspects may perform functional blocks, steps, operations, methods, etc. using orderings different from those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other aspects whether or not explicitly mentioned or described herein.

The breadth and scope of the disclosure should not be limited by any of the above-described exemplary aspects, but should be defined only in accordance with the following claims and their equivalents.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments or examples, at least one of the components set forth in one or more of the preceding figures may be configured to perform one or more operations, techniques, processes, and/or methods as set forth in the example section below. For example, circuitry associated with a thread device, routers, network element, etc. as described above in connection with one or more of the preceding figures may be configured to operate in accordance with one or more of the examples set forth below in the example section.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should only occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of, or access to, certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

What is claimed is:

1. A computing device, comprising:
a system clock configured to indicate a current time of the computing device that is approximately equal to a real physical time;
a processor coupled to the system clock; and
a time adaption layer operated by the processor and comprising a time simulator to provide a simulated current time that is substantially different from the real physical time, wherein a first program is operated by the processor based on the current time provided by the system clock at the real physical time, and a second program is operated based on the simulated current time provided by the time simulator at the real physical time.

2. The computing device of claim 1, wherein the simulated current time is a past time or a future time of the current time indicated by the system clock.

3. The computing device of claim 1, wherein the processor is a first processor, and the second program is operated by a second processor coupled to the computing device by a communication link.

4. The computing device of claim 1, wherein the real physical time is a first real physical time, the current time indicated by the system clock is a first current time, the simulated current time provided by the time simulator at the first real physical time is a first simulated current time, and wherein the first program is further operated by the processor based on a second current time provided by the system clock at a second real physical time, and the second program further operates based on a second simulated current time provided by the time simulator at the second real physical time, wherein a system time difference between the first current time and the second current time is substantially different from a simulated time difference between the first simulated current time and the second simulated current time.

5. The computing device of claim 4, wherein the simulated time difference is a multiple of the system time difference.

6. The computing device of claim 1, wherein the simulated current time is included in a header contained in a remote procedure call message sent from the time simulator to the second program.

7. The computing device of claim 1, further comprising:
a task scheduler operated by the processor, wherein the task scheduler is configured to receive the simulated current time provided by the time simulator and further transmit the simulated current time to the second program.

8. The computing device of claim 7, wherein the task scheduler, the time simulator, and the time adaption layer are operated by the processor based on the current time provided by the system clock.

9. The computing device of claim 7, wherein the task scheduler is configured to pause the second program from accessing the simulated current time for a predetermined period of time, and wherein the second program stops operations related to the simulated current time during the predetermined period of time.

10. The computing device of claim 9, wherein the task scheduler is configured to resume the second program for accessing a simulated current time after the predetermined period of time lapses, and wherein the second program performs operations related to the simulated current time after the predetermined period of time.

11. A method performed by a computing device, comprising:
generating, by a system clock, a current time of the computing device that is approximately equal to a real physical time;
providing, by the system clock, the current time to a first program operated by a processor of the computing device;
generating, at the real physical time and by a time simulator of a time adaption layer operated by the processor, a simulated current time that is substantially different from the real physical time; and
providing, at the real physical time, the simulated current time to a second program for the second program to perform operations based on the simulated current time.

12. The method of claim 11, wherein the real physical time is a first real physical time, the current time is a first current time, the simulated current time provided by the time simulator at the first real physical time is a first simulated current time, and the method further comprises:
providing to the first program a second current time generated by the system clock at a second real physical time; and
providing, at the second physical time, a second simulated current time generated by the time simulator to the second program, wherein a system time difference between the first current time and the second current time is substantially different from a simulated time difference between the first simulated current time and the second simulated current time.

13. The method of claim 11, wherein the providing the simulated current time to the second program includes providing the simulated current time in a header contained in a remote procedure call message sent from the time simulator to the second program.

14. The method of claim 11, wherein the providing the simulated current time to the second program includes:
receiving, by a task scheduler operated by the processor, the simulated current time provided by the time simulator; and
transmitting, by the task scheduler, the simulated current time to the second program.

15. The method of claim 14, further comprising:
pausing, by the task scheduler, the second program from accessing the simulated current time for a predetermined period of time, and wherein the second program stops operations during the predetermined period of time.

16. The method of claim 15, further comprising:
resuming the second program for accessing a simulated current time after the predetermined period of time lapses, and wherein the second program performs operations related to the simulated current time after the predetermined period of time.

17. A non-transitory computer-readable medium storing instructions that, when executed by a processor of a computing device, cause the computing device to perform operations, the operations comprising:
generating, by a system clock, a current time of the computing device that is approximately equal to a real physical time;
providing, by the system clock, the current time to a first program operated by a processor of the computing device;
generating, at the real physical time and by a time simulator of a time adaption layer operated by the processor, a simulated current time that is substantially different from the real physical time; and
providing, at the real physical time, the simulated current time to a second program for the second program performing operations based on the simulated current time,

18. The non-transitory computer-readable medium of claim 17, wherein the real physical time is a first real physical time, the current time indicated by the system clock is a first current time, the simulated current time provided by the time simulator at the first real physical time is a first simulated current time, and the operations further comprising:
providing, at a second real physical time, a second current time generated by the system clock to the first program;
providing, at the second physical time, a second simulated current time generated by the time simulator to the second program, wherein a system time difference between the first current time and the second current time is substantially different from a simulated time difference between the first simulated current time and the second simulated current time.

19. The non-transitory computer-readable medium of claim 17, wherein the providing the simulated current time to the second program includes providing the simulated current time in a header contained in a remote procedure call message sent from the time simulator to the second program.

20. The non-transitory computer-readable medium of claim 17, wherein the providing the simulated current time to the second program includes:
receiving, by a task scheduler operated by the processor, the simulated current time provided by the time simulator; and
transmitting, by the task scheduler, the simulated current time to the second program.
